(19) United States
(12) Patent Application Publication
(10) Pub. No.: US 2026/0013605 A1
(43) Pub. Date: Jan. 15, 2026

(54) SUNSHADE SYSTEM

(71) Applicants: Gomin Samantha Gardiyehewa, Cary, NC (US); Kudarallage Janaka Jigeeshu Perera, Cary, NC (US)

(72) Inventors: Gomin Samantha Gardiyehewa, Cary, NC (US); Kudarallage Janaka Jigeeshu Perera, Cary, NC (US)

(21) Appl. No.: 18/771,624

(22) Filed: Jul. 12, 2024

(51) Int. Cl. A45B 23/00

(52) U.S. Cl. CPC A45B 23/00; A45B 2023/0093

(57) ABSTRACT

An improved sunshade wherein the canopy is partially supported by wind. It has an improved frame shape, canopy and uses spiral blade anchors to secure the sunshade to the ground.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to an improved sunshade. In particular, it relates to a new shape and anchoring system for a sunshade.

### Description of Related Art

The sunshade is an integral part of protecting someone outdoors from the rays of the sun. The current sunshade that is supported at least in part by the wind involves a curved arch that limits the room available under the shade. In addition, since there is a single chord through the entirety of the frame and the pole is in different sections, if a single section needs replacement, it becomes difficult to impossible to replace. Lastly, the corkscrew shaped anchors pull out easily during high wind leading to structure failure and frequently require weights to be utilized on the anchor.

### BRIEF SUMMARY OF THE INVENTION

The present invention relates to the discovery that rectangular shaped support poles, instead of one curved pole, give substantially more room under the shade system, less wind noise and more of an unobstructed view. In addition, use of a spiral blade anchor, instead of corkscrew shape, improves stability of the frame under high winds more than would be expected.

Accordingly, in one embodiment, there is a sunshade system for placement on the ground comprising:
a) a first upright pole;
b) a second upright pole;
c) a horizontal pole;
d) a pair of right-angle connectors for attaching the horizontal pole to a top of the first pole and the second pole;
e) a pair of spiral blade anchors, each spiral blade anchor designed to attach to a bottom of either the first or second upright pole wherein each anchor has a handle for inserting the spiral blade anchors in the ground; and
f) a flexible canopy having a front edge for attaching to the horizontal pole and the top of the first and second upright pole.

In another embodiment there is a right angle connector comprising a goose neck pipe having a first and second side with connectors at each of the first and second end.

### BRIEF DESCRIPTION OF THE DRAWINGS

FIG. 1 is a perspective view of the sunshade system of the invention.

FIG. 2 is a frontal view of the rectangular frame.

FIG. 3 is a perspective on an embodiment of the spiral blade anchor

FIG. 4 is a side view of a right-angle connector.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

It is further noted that the claims may be drafted to exclude any element which may be optional. As such, this statement is intended to serve as antecedent basis for use of such exclusive terminology as “solely”, “only” and the like in connection with the recitation of claim elements, or the use of a “negative” limitation.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. To the extent such publication may set out definitions of a term that conflict with the explicit or implicit definition of the present disclosure, the definition of the present disclosure controls.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “sunshade system” refers to a system designed to create a shady spot underneath a canopy for protection from the sun. In this case, it is a shade wherein the canopy is at least partially supported by wind. The canopy is attached to the horizontal pole and partially the two upright poles of a rectangular framework and the wind blowing through the canopy lifts the opposite end of the canopy creating a shady space.

As used herein, the term “first upright pole, second upright pole” refers to 2 upright poles of the same height. They can be single piece poles or in one embodiment sections of poles with an optional shock chord to make for easy assembly of each pole. The bottom of each of the upright poles is each placed into spiral blade anchors and attached thereto to support them in the wind.

As used herein, the term “horizontal pole” refers to a pole designed to attach to the top of each of the upright poles. It is connected to each top of the upright poles via a right-angle connector, creating a rectangular structure from the three poles and two connectors (as shown in one embodiment in the drawings). The horizontal pole can be a single piece or in sections with or without a shock cord for easy assembly. One edge of the canopy will be attached to the horizontal pole.

As used herein, the term “right angle connectors” refers to a connector designed to attach to the top of an upright pole and into one end of the horizontal pole to create a 3-pole rectangular frame. In one embodiment it is a bent flexible goose neck pipe and material that connects to the top of an upright pole and an end of the horizontal pole to keep them at about right angles relative to one another is contemplated.

As used herein, the term “spiral blade anchors” refers to an earth anchor with spiral blades (as shown in the figures) as opposed to a spiral wire taught in the prior art. The anchor will have a handle to assist screwing the anchor into the ground. At its top will be an opening to accommodate the bottom of one of the upright poles. A set screw holds the pole in the anchor. These anchors can also be used with guy lines on the frame and canopy as needed to further stabilize the frame. In one optional embodiment an adapter for different diameter pole, which sets into the open top.

As used herein, the term “handle” refers to a top portion of the anchor that allows the user to twist the anchor into the ground. It needs to be utilized by at least one hand.

As used herein, the term “flexible canopy” refers to a sheet of material that comprises the top shady portion of the system. One edge is attached to the horizontal pole and a portion of the two upright poles and the rest of the canopy at least partially supported by wind. The canopy can be rectangular, or any other shape and can be a single piece of multiple pieces connected together to form the sheet.

As used herein, the term “set screw” refers to a screw in the blade anchor that holds the bottom of an upright pole in place.

As used herein, the term “shock cord” refers to an elastomeric chord usually woven outer layer and rubber or the like on the inside. This is used to stabilize or aid in assembly of poles or to stabilize the canopy where attached to the horizontal pole.

As used herein, the term “multiple sections” refers to any of the poles being multiple pieces which fit together to make a single pole. In one embodiment the multiple sections are shock chorded for easy assembly into a straight pole.

As used herein, the term “device on each of the upright poles” refers to a device on each of the upright poles to attach each end of a chord used to tie the upright poles in the front edge of the canopy. In one embodiment there is a device to tighten or loosen the chord. The chord attaches to an end of the canopy and to the device.

As used herein, the term “flexible goose neck pipe” refers to an embodiment wherein the right-angle connecter is constructed to bend to any angle including a right angle to keep the top pole and upright poles in about a 90-degree connection. The pipe will have suitable connectors to attach to the pipes. In one embodiment, the flexible pipe is pre-attached to one of the poles so only one end needs attachment.

### DRAWINGS

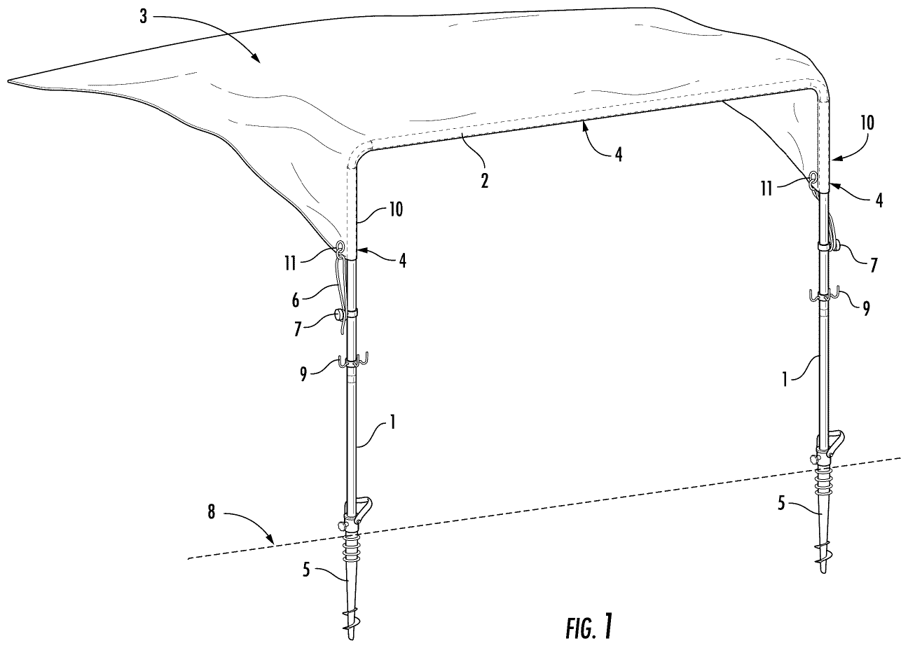

Now referring to the drawings, FIG. 1 is a perspective view of the sunshade system of the invention. In this view, the frame has two upright poles 1 and horizontal pole 2 (covered by a canopy in this view). The three poles form a rectangular structure. A canopy 3 has a front edge 4 attached to horizontal pole 2 and a portion of each upright pole 1. Each of the upright poles is imbedded in the ground 8 by spiral blade anchors 5 positioned at a bottom of each upright pole. A chord 6 is attached to the edge 11 of canopy 3 and is tied to connector 7. The attachment to upright poles 1 can have an additional member to tighten or loosen chord 6. Optional hook 9 is shown attached to upright poles 1 designed to hang clothing and the like.

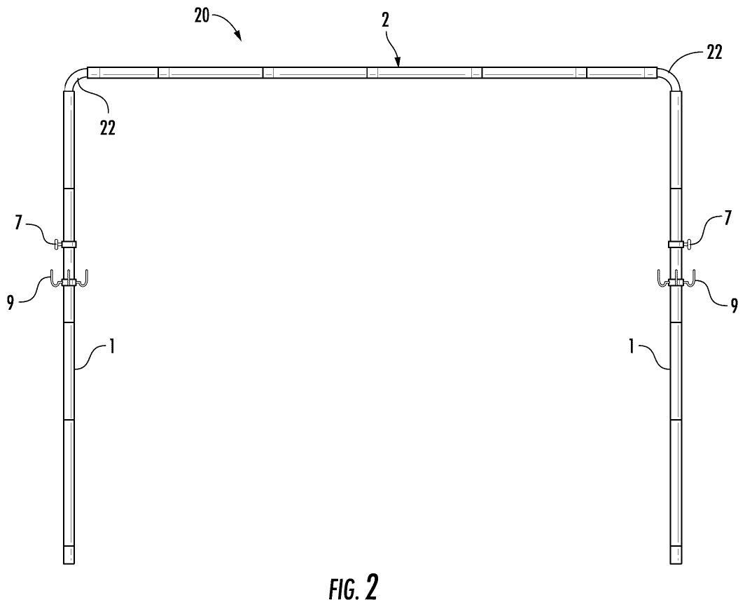

FIG. 2 is a frontal view of the rectangular frame 20 wherein each upright pole 1 is formed in sections and optionally shock chorded for easy assembly. The horizontal pole 2 is attached to the top of each upright pole 1 via right angle connector 22. The horizontal pole can also be in sections.

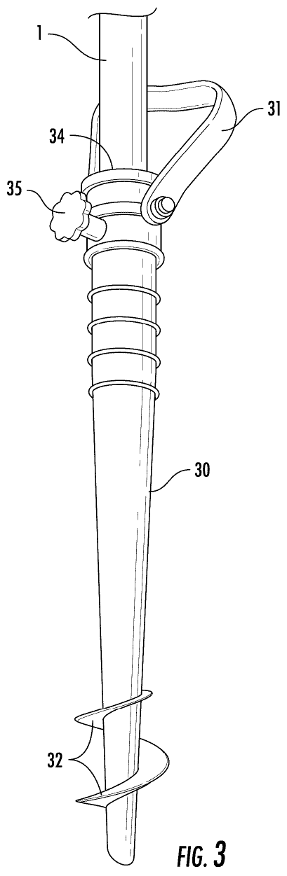

FIG. 3 is a perspective on an embodiment of the spiral blade anchor 30. The spiral blade anchor 30 is screwed into the ground using handle 31. The spiral blades 32 are shown at a bottom of the anchor. The bottom end of an upright pole 1 is shown inserted into a top receptacle 34 on the anchor. It can be secured with screw 35.

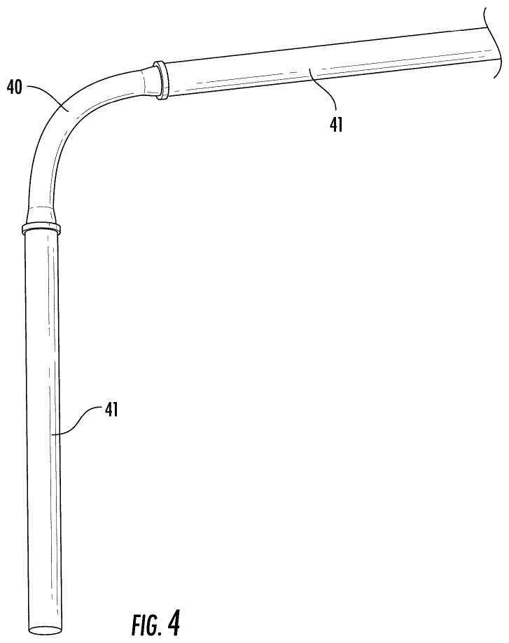

FIG. 4 is a side view of an embodiment of a right-angle connector. In this view, flexible pipe 40 is bent so that the angle created is 90 degrees. Fitting 41 allows connection to upright and horizontal poles.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A sunshade system for placement on the ground comprising:
a) a first upright pole;
b) a second upright pole;
c) a horizontal pole;
d) a pair of right-angle connectors for attaching the horizontal pole to a top of the first pole and the second pole;
e) a pair of spiral blade anchors, each spiral blade anchor designed to attach to a bottom of either the first or second upright pole wherein each anchor has a handle for inserting the spiral blade anchors in the ground; and
f) a flexible canopy having a front edge for attaching to the horizontal pole and the top of the first and second upright pole.

2. The sunshade system according to claim 1 wherein each spiral blade anchor has a set screw for holding the first and second upright pole in place in the spiral blade anchor.

3. The sunshade system according to claim 1 wherein the canopy front edge has a sleeve where horizontal pole is inserted into and each end of canopy is attached to one of the upright poles.

4. The sunshade system according to claim 1 wherein each of the first upright, second upright and horizontal poles are in multiple sections and are shock chorded.

5. The sunshade system according to claim 1 wherein at least one of the first and second upright poles has one or more hooks to hang things on.

6. The sunshade system according to claim 4 wherein there is device on each of the upright poles to hook chord 6.

7. The sunshade system according to claim 1 wherein the right-angle connectors are a flexible goose neck pipe.

8. A right angle connector comprising a goose neck pipe having a first and second side with connectors at each of the first and second end.
